(19) United States
(12) Patent Application Publication
(10) Pub. No.: US 2004/0243491 A1
(43) Pub. Date: Dec. 2, 2004

(54) Bill of material comparison system and method

(76) Inventor: Sung-Jen Hsiang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/807,209

(22) Filed: Mar. 22, 2004

(30) Foreign Application Priority Data
Mar. 21, 2003 (TW) 92106303

(51) Int. Cl. G06F 17/60

(52) U.S. Cl. 705/34

(57) ABSTRACT

A bill of material (BOM) comparison system includes a database (130) comprising a changed BOM file (1310), an original BOM file (1320) and a comparative BOM file (1330), and a BOM comparison module (1020) for comparing contents of changed BOM files and original BOM files. A BOM comparison method includes the steps of: retrieving a changed BOM file and an original BOM file; generating a changed sub-file according to the changed BOM file; generating an intermediate sub-file according to the original BOM file; comparing information on parts in the changed sub-file with information on parts in the intermediate sub-file; generating a plurality of sub-files to record comparative results; and integrating the sub-files into a comparative BOM file.

### BACKGROUND OF THE INVENTION

1. Field of the Invention

The present invention relates to systems and methods for processing data by computer systems, and particularly to a bill of material (BOM) comparison system and method for comparing of current BOMs with corresponding original BOMs by computerized manufacturing management systems when a change in design of a product occurs.

2. Background of the Invention

ORCAD is an application software widely used in electrical circuit designing. ORCAD runs on a Windows operation system, and generates Bills of Material (BOMs) for manufacturing management and inventory control. Normally, the generated BOMs of ORCAD are not fully suited for the specified requirements of manufacturing systems. Therefore, operators manually compare the current BOMs output by ORCAD with corresponding original BOMs, input differences between every two corresponding BOMs, and generate comparative BOMs according to the manufacturing requirements. However, such manual comparison required for the manufacturing process is inefficient and costly.

Information computerization may be used to address this problem. Pertinent art of information computerization is disclosed in US. Pat. No. 5,630,070 entitled “Optimization of Manufacturing Resource Planning.” The invention optimizes manufacturing resource planning according to an optimization algorithm, and generates a matrix comprising a BOM and manufacturing limitations. The limitations comprise a constraint on the amount of products shipped, a constraint on inventory, and a constraint on available time for use of resources. However, other relevant information is not provided to operators of the invention. For example, when a change of design occurs, information on changes of parts and assembly methods is not timely sent to the operators. Furthermore, a current BOM cannot be compared with an original BOM automatically.

Accordingly, it is desired to provide a BOM comparison system and method which can automatically compare current BOMs with corresponding original BOMs for the purposes of recording differences between the BOMs if any change of design occurs.

### SUMMARY OF THE INVENTION

A main objective of the present invention is to provide a BOM comparison system and method for automatically comparing current BOMs with corresponding original BOMs, and recording differences between the BOMs if any change of design occurs.

To accomplish the above objective, a BOM comparison system in accordance with a preferred embodiment comprises a database including a changed BOM file, an original BOM file and a comparative BOM file, and a BOM comparison module. The changed BOM file stores current BOMs that need to be compared. The original BOM file stores corresponding original BOMs that can be used to compared with the current BOMs. The comparative BOM file stores output of the BOM comparison system, (namely, comparative results of the changed BOM file and the original BOM file). The BOM comparison module is used for comparing contents of the changed BOM file and the original BOM file, and generating a comparative BOM file.

Further, the present invention provides a BOM comparison method comprising the steps of: (a) opening a changed BOM file and an original BOM file by accessing a database; (b) generating a changed sub-file according to the changed BOM file; (c) generating an intermediate sub-file according to the original BOM file; (d) comparing information on parts in the changed sub-file with corresponding information on parts in the intermediate sub-file; (c) generating a plurality of sub-files to record comparative results; and (d) integrating the sub-files into a comparative BOM file.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of hardware configuration of a bill of material (BOM) comparison system in accordance with the preferred embodiment of the present invention;

FIG. 2 is a schematic diagram of main files of a database, and of main function modules of a database server and a designing computer of FIG. 1;

FIG. 3 is a schematic diagram of sub-files of a comparative BOM file of the database of FIG. 2;

FIG. 4 is a schematic diagram of function sub-modules of a BOM comparison module of FIG. 2; and

FIG. 5 is a flowchart of a preferred BOM comparison method in accordance with the present invention.

### DETAILED DESCRIPTION OF THE INVENTION

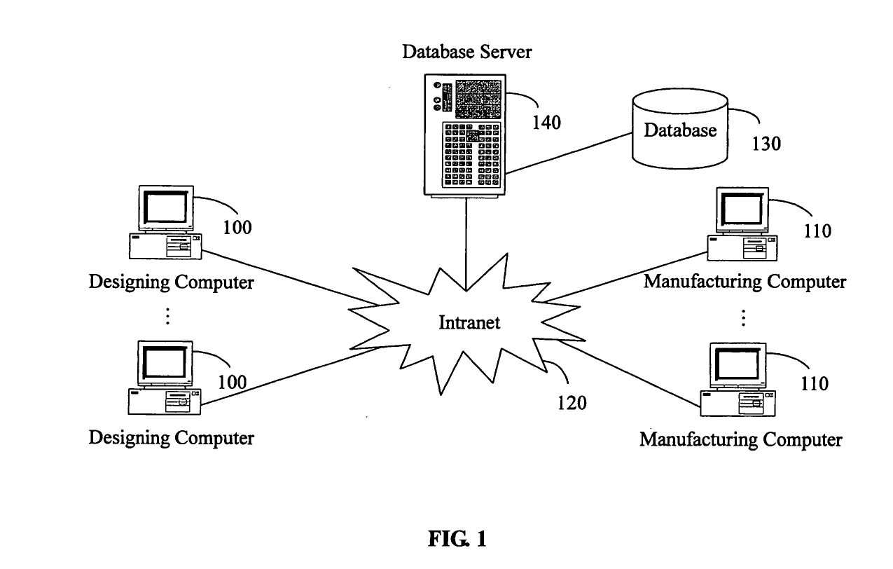

FIG. 1 is a schematic diagram of hardware configuration of a BOM (Bill of Material) comparison system in accordance with the preferred embodiment of the present invention. The BOM comparison system comprises a database server 140, a database 130, and a plurality of designing computers 100 and manufacturing computers 110. The database server 140, the designing computers 100, and the manufacturing computers 110 are interconnected through an Intranet 120. The database 130 is linked to the database server 140 via database connectivity known in the art, such as an ODBC (Open Database Connectivity, not labeled in FIG. 1).

The database 130 stores relevant data used or generated in implementing the BOM comparison system. The database server 140 manages access to files in the database 130, and maintains such files. The database server 140 can update and search large amounts of data quickly. The designing computers 100 are located at different places in an organization that implements the BOM comparison system. Each designing computer 100 executes a software program in order to implement BOM comparison operations. The manufacturing computers 110 are provided for maintaining files in the database 130, and obtaining and outputting implementation results of the BOM comparison system. The manufacturing computers 110 may be general-purpose computer devices such as personal computers, laptops, portable handheld devices (e.g., personal digital assistants—PDAs), or other suitable input/output devices known in the art.

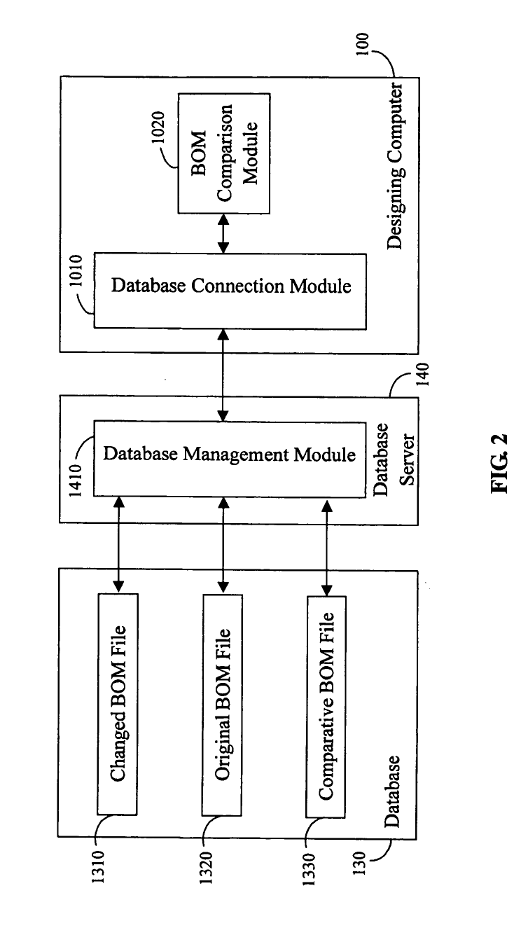

FIG. 2 is a schematic diagram of main files of the database 130, and of main function modules of the database server 140 and the software program executed by any one of the designing computers 100. The designing computer 100 comprises a database connection module 1010, and a BOM comparison module 1020. The database server 140 comprises a database management module 1410. The database 130 comprises a changed BOM file 1310, an original BOM file 1320, and a comparative BOM file 1330. A BOM is a detailed bill of materials needed for manufacturing a product. For example, if the product is an electronic product such as a motherboard, the materials may comprise electronic parts attached on the motherboard. Items in a BOM include a product name, a product version, names and amounts of the parts, and positions of the parts in the product.

The changed BOM file 1310 stores current BOMs that need to be compared. The current BOMs are generated after a change of design has been made by application software (e.g., ORCAD software) installed in the designing computer 100. The changed BOM file 1310 comprises a product name, a product version, and information on parts for the product. The information on parts comprises columns for: “item,” “quantity,” “reference,” “part” and “description.” The columns respectively mean: a part item name, a quantity of the part in the product, the part's position in the product, the part's specification, and a detailed description of the part. The original BOM file 1320 stores original BOMs output by the BOM comparison system before a change of design. The original BOMs are typically in a format compatible with Microsoft Excel (hereinafter, “Excel compatible files”). Items defined in the original BOM file 1320 are identical with those defined in the changed BOM file 1310. That is, the original BOM file 1320 comprises the product name, the product version, and information on parts for the product. The information on parts comprises part item names, quantities of the parts in the product, the parts' positions in the product, the parts' specifications, and detailed descriptions of the parts.

The BOM comparison module 1020 is provided for comparing the changed BOM file 1310 with the original BOM file 1320, recording comparative results, and generating a comparative BOM file 1330. The comparative results comprise data on differences between the changed BOM file 1310 and the original BOM file 1320. Such differences can include parts that are added or deleted, and changes in the quantities and positions of parts. The comparative BOM file 1330 stores the Excel compatible files, in order to inform operators of the data on differences in real time. The comparative BOM file 1330 comprises a content of the changed BOM file 1310, and the corresponding comparative results.

The database connection module 1010 connects the BOM comparison module 1020 in the designing computer 100 and the database management module 1410, through which the BOM comparison module 1020 accesses and browses the files in the database 130. The BOM comparison module 1020 accesses data in various databases via the database connection module 1010. The database connection module 1010 may utilize an Open Database Connectivity (ODBC).

The database management module 1410 is provided for managing the changed BOM file 1310, the original BOM file 1320 and the comparative BOM file 1330 stored in the database 130, and for creating, adding, deleting, updating and inquiring of records in said files 1310, 1320, 1330. All the files in the database 130 are input by the designing computers 100 or the manufacturing computers 110 as Excel compatible files via the database connection module 1010.

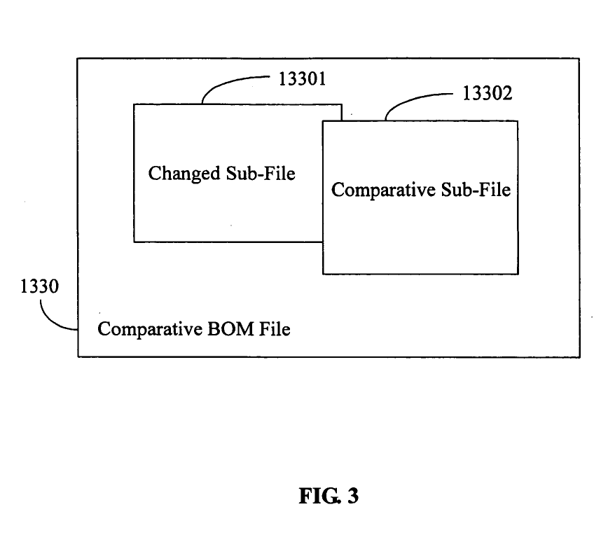

FIG. 3 is a schematic diagram of sub-files in the comparative BOM file 1330 of the database 130. The comparative BOM file 1330 comprises a changed sub-file 13301 and a comparative sub-file 13302. Said two sub-files 13301, 13302 generally appear in the form of Excel sheets.

The changed sub-file 13301 records data on all parts accessed by the changed BOM file 1310, and comprises columns for: “product name,” “version,” “item,” “quantity,” “method,” “reference,” “part,” and “description.” These columns respectively mean: a product name, a product version, a part item name, a quantity of the part in the product, an assembly method, the part's position in the product, the part's specification, and a detailed description of the part. The data on parts can be stored after being sorted according to manufacturing requirements specified by the BOM comparison system.

The comparative sub-file 13302 records comparative results of the changed sub-file 13301 and the original BOM file 1320. The comparative results comprise columns for: “item change,” “quantity change,” and “location change.” These columns respectively record: parts that are added or deleted, changes in quantities of parts, and changes in positions of parts.

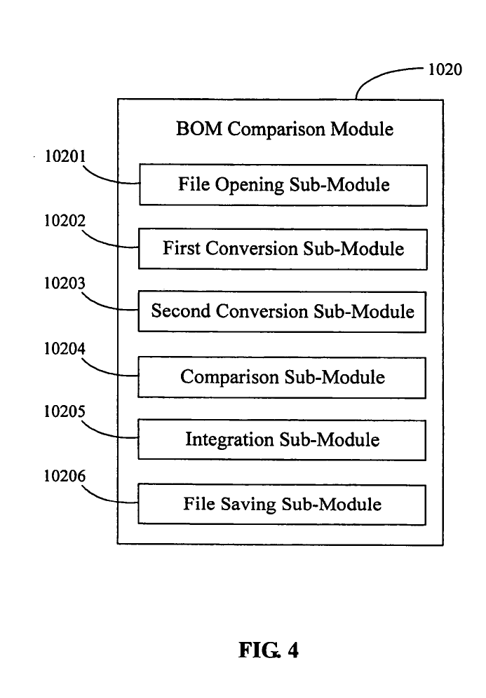

FIG. 4 is a schematic diagram of function sub-modules of the BOM comparison module 1020 of any one of the designing computers 100. The BOM comparison module 1020 comprises: a file opening sub-module 10201 for opening the changed BOM file 1310 and the original BOM file 1320 by accessing the database 130; a first conversion sub-module 10202 for inputting a content of the changed BOM file 1310 into the changed sub-file 13301; a second conversion sub-module 10203 for copying a content of the original BOM file 1320 into an intermediate sub-file (not shown in the figures); a comparison sub-module 10204 for comparing a content of the changed sub-file 13301 with a content of the intermediate sub-file, and for recording comparison results in the comparative sub-file 13302; an integration sub-module 10205 for integrating contents of the changed sub-file 13301 and the comparative sub-file 13302 into the comparative BOM file 1330; and a file saving sub-module 10206 for storing the comparative BOM file 1330 by accessing the database 130.

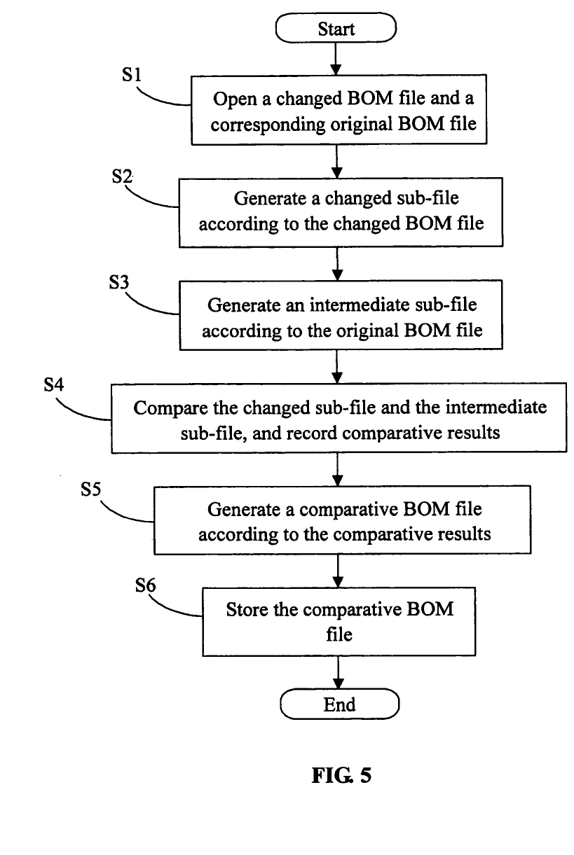

FIG. 5 is a flowchart of a preferred BOM comparison method according to the present invention. In step S1, the file opening sub-module 10201 opens a changed BOM file 1310 and a corresponding original BOM file 1320 by accessing the database 130. In step S2, the first conversion sub-module 10202 inputs the content of the changed BOM file 1310 into a changed sub-file 13301 in the format of Excel sheets. The content of the changed BOM file 1310 comprises a part item name, a quantity of the part in the product, the part's position in the product, the part's specification, and a detailed description of the part. In step S3, the second conversion sub-module 10203 copies the content of the original BOM file 1320 into an intermediate sub-file (not shown in the figures). The intermediate sub-file is in the format of Excel sheets, whose columns are identical to those of the changed sub-file 13301. In step S4, the comparison sub-module 10204 compares the content of the changed sub-file 13301 with the content of the intermediate sub-file, and records comparative results in a comparative sub-file 13302. In step S5, the integration sub-module 10205 integrates contents of the changed sub-file 13301 and the comparative sub-file 13302 into a comparative BOM file 1330. In step S6, the file saving sub-module 10206 stores the comparative BOM file 1330 in the database 130.

In general, the BOM comparison system and method of the present invention may take forms other than what is described above. While preferred embodiments for carrying out the present invention have been described in detail, those familiar with the art to which the invention relates will recognize various alternative designs and embodiments for practicing the present invention. These alternative designs and embodiments are within the scope of the present invention, which is defined by the claims appended hereto and allowable equivalents thereof.

What is claimed is:

1. A bill of material (BOM) comparison system for automatically comparing current BOMs with corresponding original BOMs, and recording differences between the BOMs if any change of design occurs, the system comprising:
a database comprising a changed BOM file for storing BOMs that need to be compared, and an original BOM file for storing corresponding original BOMs that can be compared with the current BOMs; and
a BOM comparison module for comparing contents of the changed BOM file and the original BOM file, and for generating a comparative BOM file.

2. The BOM comparison system according to claim 1, wherein the system comprises a plurality of BOM comparison modules, each of which is installed in a respective designing computer.

3. The BOM comparison system according to claim 1, wherein the changed BOM file and the original BOM file comprise information on parts, including part item names, amounts of the parts in a product, the part's positions in the product, the part's specifications, and detailed descriptions of the parts.

4. The BOM comparison system according to claim 1, wherein the comparative BOM file comprises a changed sub-file and a comparative sub-file.

5. The BOM comparison system according to claim 1, further comprising a database connection module for connecting the BOM comparison module with the files in the database, said files comprising the changed BOM file, the original BOM file and the comparative BOM file.

6. The BOM comparison system according to claim 1, further comprising a database server that comprises a database management module for managing the changed BOM file, the original BOM file and the comparative BOM file, and for creating, adding, deleting, updating and inquiring of said files.

7. A bill of material (BOM) comparison method for automatically comparing current BOMs with corresponding original BOMs, and for recording differences between the BOMs if any change of design occurs, the method comprising the steps of:
retrieving a changed BOM file and an original BOM file;
generating a changed sub-file according to the changed BOM file;
generating an intermediate sub-file according to the original BOM file;
comparing information on parts in the changed sub-file with information on parts in the intermediate sub-file;
generating a plurality of sub-files to record comparative results; and
integrating the sub-files into a comparative BOM file.

8. The BOM comparison method according to claim 7, wherein the information on the parts comprises part item names, amounts of the parts in a corresponding product, the parts' positions in the product, the parts' specifications, and detailed descriptions of the parts.

9. The BOM comparison method according to claim 7, wherein the comparative results comprise any one or more of parts that are added or deleted, and changes to amounts and positions of parts.

10. The BOM comparison method according to claim 7, wherein the sub-files comprise a changed sub-file and a comparative sub-file.
